(19) United States
(12) Patent Application Publication
(10) Pub. No.: US 2024/0342947 A1
(43) Pub. Date: Oct. 17, 2024

(54) A WOOD PRESERVATIVE COMPOSITION COMPRISING 4,5-DICHLORO-2-OCTYLISOTHIAZOL-3(2H)-ONE, A METHOD TREATING A WOOD SUBSTRATE THEREWITH, AND A WOOD PRODUCT PRODUCED THEREFROM

(71) Applicant: KOPPERS PERFORMANCE CHEMICALS, INC., Pittsburgh, PA (US)

(72) Inventors: Min Kuang, Peachtree City, GA (US); Jun Zhang, Peachtree City, GA (US)

(21) Appl. No.: 18/294,874

(22) PCT Filed: Aug. 5, 2022
(86) PCT No.: PCT/US2022/074623

§ 371 Date: Feb. 2, 2024

Related U.S. Application Data
(60) Provisional application No. 63/229,817, filed on Aug. 5, 2021.

(51) Int. Cl. B27K 3/40; A01N 43/80

(52) U.S. Cl. CPC B27K 3/40; A01N 43/80; B27K 2200/10; B27K 2200/30; B27K 2240/50

(57) ABSTRACT

A wood preservative composition comprising 4.5-dichloro-2-octylisothiazol-3 (2H)-one, a method of treating a wood substrate therewith, and a wood product produced therefrom are provided. The wood preservative composition comprises at least 10% by weight of 4.5-dichloro-2-octylisothiazol-3-one (DCOI) based on the total weight of the composition, at least 10% by weight of a non-polar organic solvent based on the total weight of the composition, and at least 1% by weight of a polar organic solvent based on the total weight of the composition. A weight ratio of the non-polar organic solvent to the polar organic solvent is in a range of 80:1 to 1:8.

### CROSS-REFERENCE

The present application claims priority to U.S. Provisional Application No. 63/229,817, filed Aug. 5, 2021, the entire contents of which is hereby incorporated by reference in its entirety.

### FIELD

The present disclosure relates to a wood preservative composition comprising 4,5-dichloro-2-octylisothiazol-3 (2H)-one, a method of treating a wood substrate therewith, and a wood product produced therefrom.

### BACKGROUND

Oil-borne preservatives, such as, for example, pentachlorophenol (Penta) in hydrocarbon solvent carriers have been used as heavy-duty industrial wood preservative to treat, for example, utility poles for many decades. Oil-borne preservatives comprising Penta may impart treated wood with excellent resistance to wood decay fungi and termites as well as potentially desirable climbability, electrical resistance, and inhibition of corrosion of hardware. However, in 2015, the Stockholm Convention classified Penta as a persistent organic pollutant (POP) and proposed to discontinue its use. In 2019, the only North American producer of Penta made an announcement that they will close its manufacturing plant and a blending facility at the end of 2021. In March 2021, the EPA made a proposal to cancel all uses of Penta through the Federal Insecticide, Fungicide and Rodenticide Act (FIFRA) registration review process. Therefore, an alternative oil-borne preservative to oil-borne preservatives comprising Penta is desired.

### SUMMARY

The present disclosure provides a wood preservative composition comprising at least 10% by weight of 4,5-dichloro-2-octylisothiazol-3-one (DCOI) based on the total weight of the composition, at least 10% by weight of a non-polar organic solvent based on the total weight of the composition, and at least 1% by weight of a polar organic solvent based on the total weight of the composition. A weight ratio of the non-polar organic solvent to the polar organic solvent is in a range of 80:1 to 1:8.

The present disclosure also provides a wood preservative composition comprising 15% by weight to 45% by weight of DCOI based on the total weight of the composition, 30% by weight to 80% by weight of a non-polar organic solvent based on the total weight of the composition, and an amount of a polar organic solvent suitable to increase the stability of the wood preservative composition during storage at 5 degrees Celsius for 24 hours.

The present disclosure also provides a wood preservative composition comprising at least 0.5% by weight of DCOI based on the total weight of the composition, at least 50% by weight of a non-polar organic solvent based on the total weight of the composition, and at least 10 ppm by weight of a de-emulsifier based on the total weight of the composition.

The present disclosure also provides a wood preservative composition comprising 0.5% by weight to 10% by weight of DCOI based on the total weight of the composition, 50% by weight to 99% by weight of a non-polar organic solvent based on the total weight of the composition, and an amount of a de-emulsifier suitable to enhance water separation from the wood preservative composition compared to a wood preservative composition without the de-emulsifier.

The present disclosure also provides a method for treating a wood substrate. The method comprises diluting a concentrated composition according to the present disclosure to form a diluted treating solution and contacting the wood substrate with the diluted treating solution for a period of time suitable to inhibit fungal decay of the wood substrate.

The present disclosure also provides a method for treating a wood substrate. Contacting the wood substrate with a wood preservative composition according to the present disclosure for a period of time suitable to inhibit fungal decay of the wood substrate.

The present disclosure also provides a wood product produced by treating a wood substrate with a wood preservative composition according to the present disclosure.

The present disclosure also provides a wood product comprising a wood preservative composition according to the present disclosure.

It is understood that the inventions described in this specification are not limited to the examples summarized in this Summary. Various other aspects are described and exemplified herein.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

4,5-dichloro-2-octylisothiazol-3 (2H)-one (DCOI) has been used in wood preservative compositions for mold control and antibacterial activity. DCOI dissolved in hydrocarbon solvents has also been proposed to treat wood for heavy duty applications but has been challenging to implement. The present disclosure provides a wood preservative composition comprising DCOI, a non-polar organic solvent, and a polar organic solvent that the present inventors surprisingly discovered can enhance the cold temperature stability of the wood preservative composition. The present disclosure also provides a wood preservative composition comprising DCOI, a non-polar organic solvent, and a de-emulsifier that the present inventors surprisingly discovered can enhance inhibition of the formation of an emulsion with water during a treatment process and can facilitate a fast water separation from the solvent phase.

The wood preservative composition according to the present disclosure can be a concentrated composition or a diluted treating composition. The concentration composition comprises DCOI, a non-polar organic solvent, a polar organic solvent, and optionally a de-emulsifier and/or other additives. The diluted treating composition comprises DCOI, a non-polar organic solvent, a de-emulsifier, and/or a polar organic solvent and/or other additives.

The concentration composition can be diluted with another organic solvent, which may be the same or different than the organic solvent (e.g., polar solvent, non-polar solvent) used to formulate the concentrated composition, to form the diluted treating composition. In various examples, the diluted treating composition may be directly formed without first forming the concentrated composition. In certain examples, the concentrated formulation may be formed by mixing the DCOI with the non-polar organic solvent and/or polar organic solvent at a temperature above the melting point of DCOI. The resulting concentrate can be in a liquid form. In addition, the resulting concentrate can be further diluted in another organic solvent (whether polar or non-polar) to make the final wood preservative treating composition. In certain examples, the concentrated formulation may be used to treat a wood substrate to form a wood product.

DCOI (C₁₀H₁₅Cl₂NOS) is an organic compound biocide that can inhibit fungal decay and/or insect attack of a wood product. Thus, the concentration of the DCOI in the wood preservative composition according to the present disclosure can be selected based on the desired level of inhibition of the fungal decay, desired level of inhibition of insect attack, the method used to treat the wood product, and/or the desired storage and/or shipping conditions.

The concentrated composition can comprise a concentration of DCOI of at least 10% by weight based on the total weight of the composition, such as, for example, at least 15% by weight, at least 20% by weight, at least 25% by weight, or at least 30% by weight, all based on the total weight of the composition. The concentrated composition can comprise a concentration of DCOI no greater than 50% by weight based on the total weight of the composition, such as, for example, no greater than 45% by weight, no greater than 40% by weight, no greater than 30% by weight, or no greater than 25% by weight, all based on the total weight of the composition. In various examples, the concentrated composition according to the present disclosure can comprise a concentration of DCOI in a range of 10% by weight to 50% by weight based on the total weight of the composition, such as, for example, 15% by weight to 45% by weight, 15% by weight to 40% by weight, 20% by weight to 45% by weight, 20% by weight to 30% by weight, or 20% by weight to 25% by weight, all based on the total weight of the composition. For example, the concentrated composition according to the present disclosure can comprise 23% by weight DCOI based on the total weight of the composition.

The diluted treating composition can comprise a concentration of DCOI of at least 0.5% by weight based on the total weight of the composition, such as, for example, at least 1.0% by weight, at least 2.0% by weight, at least 2.5% by weight, or at least 3.0% by weight, all based on the total weight of the composition. The diluted treating composition can comprise a concentration of DCOI no greater than 10% by weight based on the total weight of the composition, such as, for example, no greater than 9% by weight, no greater than 8% by weight, no greater than 5% by weight, no greater than 4% by weight, or no greater than 3% by weight, all based on the total weight of the composition. In various examples, the diluted treating composition according to the present disclosure can comprise a concentration of DCOI in a range of 0.5% by weight to 10% by weight based on the total weight of the composition, such as, for example, 1.0% by weight to 5.0% by weight, 1.5% by weight to 5.0% by weight, 1.5% by weight to 3.0% by weight, 2.0% by weight to 3.0% by weight, 2.0% by weight to 2.5% by weight, 1.5% by weight to 2.0% by weight, all based on the total weight of the composition. For example, the diluted treating composition according to the present disclosure can comprise 2% by weight DCOI based on the total weight of the composition.

The non-polar organic solvent does not have a dipole moment and does not have any partial positive or negative charges. For example, the non-polar organic solvent has a dielectric constant of less than 5. The non-polar organic solvent can facilitate solubilization of the DCOI and/or the penetration of the DCOI into a wood product. For example, DCOI can comprise a solubility of 2% in the non-polar organic solvent, such as, for example, at least 5% in the non-polar organic solvent. The organic solvent can comprise one solvent, or a mixture of two or more solvents based on the application and/or desired properties of the organic solvent. The non-polar organic solvent can comprise a non-polar hydrocarbon solvent (e.g., pentane, hexane, and heptane diesel #2, diesel #4, diesel #6, a non-polar aliphatic hydrocarbon solvent), a non-polar ether solvent, a non-polar ester solvent, a non-polar aliphatic solvent, a non-polar aromatic solvent, a non-polar terpene solvent, a non-polar aromatic solvent, a non-polar biodegradable organic solvent, or a combination thereof.

A dielectric constant as described herein can be measured by a dielectric constant meter, such as, for example, a BI-870 Di-Electric Constant Meter from Brookhaven Instruments, Holtsville, New York, USA.

The non-polar hydrocarbon solvent can comprise various hydrocarbon classes and chain lengths. For example, the non-polar hydrocarbon solvent can be a hydrocarbon solvent as defined in American Wood Protection Association (AWPA) 2021 Book of Standards HSA-18, HSC-17, HSF-17, HSG-18, HSH-18, or a combination thereof. The chain length and hydrocarbon classes of the non-polar hydrocarbon solvents suitable for use with the present disclosure can be selected to achieve a desired flash point of the composition and/or solubility of the DCOI. For example, the non-polar organic solvent can comprise a non-polar hydrocarbon solvent, such as, for example, diesel and/or a non-polar biodegradable organic solvent, such as, for example, biodiesel. The non-polar organic solvent can comprise a flash point of at least 20 degrees Celsius, such as, for example, at least 50 degrees Celsius or at least 60 degrees Celsius, at least 70 degrees Celsius, at least 80 degrees Celsius, at least 90 degrees Celsius, at least 100 degrees Celsius, at least 110 degrees Celsius, at least 120 degrees Celsius, at least 150 degrees Celsius, or at least 200 degrees Celsius. The non-polar hydrocarbon solvent can be derived from petroleum-based products.

The non-polar aliphatic hydrocarbon solvent can comprise, heptane, hexane, kerosene, lacquer diluent, mineral seal oil, #2 fuel oil, mineral spirits, n-pentane, OMS-odorless mineral spirits, rubber solvent, 140 Solvent, 360 Solvent, Textile Spirits®, VM&P, or a combination thereof.

The non-polar terpene solvent can comprise alpha-pinene, wood, dipentene 122®, D-limonene, Herco® pine oil, Solvenol®, steam distilled turpentine, Terpineol®, Yarmor® 302,302-W pine oil, or a combination thereof.

The non-polar aromatic solvent can comprise Aromatic 100, Aromatic 150, Aromatic 200, Aromatic 200ND, Heavy Aromatic Solvent, Panasol®, toluene, xylene, or a combination thereof.

The non-polar biodegradable organic solvent can comprise vegetable oil (e.g., renewable resource oil), biodiesel, or a combination thereof. Vegetable oil refers to compounds extracted from plants. For example, the compounds extracted from plants are primarily triglyceride-based, and present as liquid, fatty waxy, or solid state at room temperature. Vegetable oils that are waxy or solid at room temperature are also called vegetable fats. In Addition, vegetable oil contains both saturated and unsaturated carbon-carbon double bonds.

Unsaturated vegetable oils can be transformed through partial or complete hydrogenation into oils of higher melting point. The hydrogenation process involves sparging the oil at a high temperature and a high pressure with hydrogen in the presence of a catalyst, typically a nickel-based compound. As each carbon-carbon double-bond is chemically reduced to a single bond, two hydrogen atoms each form single bonds with the two carbon atoms to increase its degree of saturation. An oil may be hydrogenated to increase resistance to rancidity (oxidation) or to change its physical characteristics. As the degree of saturation increases, the oil's viscosity and melting point increase.

The vegetable oil can comprise linseed oil, coconut oil, corn oil, cottonseed oil, palm oil, canola oil, palm kernel oil, olive oil, peanut oil, rapeseed oil, safflower oil, sesame oil, soybean oil, sunflower oil, castor oil, tung oil, poppyseed oil, vernonia oil, almond oil, beech nut oil, Brazil nut oil, virgin oil, cashew oil, hazelnut oil, macadamia oil, mongongo nut oil (manketti oil), pecan oil, pine nut oil, pistachio oil, walnut oil, pumpkin seed oil, pracaxi oil, grape seed oil, rice bran oil, carapa oil, hempseed oil, or a combination thereof.

Renewable resource oil is derived from sustainable and renewable sources of fatty acids and resins, such as tall oil. Tall oil, also called “liquid rosin” or tallol, is a yellow-black liquid obtained as a by-product of wood pulping process. Tall oil is the third largest chemical by-product in a Kraft mill after lignin and hemicellulose; the yield of crude tall oil from the process is in the range of 30-50 kg/ton pulp, and it has been produced commercially since the 1930s. Biodiesel refers to a vegetable oil- or animal fat-based diesel fuel comprising long-chain alkyl (methyl, ethyl, or propyl) esters. Biodiesel is typically made by chemically reacting lipids (e.g., vegetable oil, soybean oil, [1] animal fat (tallow [2] [3])) with an alcohol producing fatty acid esters.

The non-polar organic solvent can comprise a flash point of at least 20 degrees Celsius, such as, for example, at least 30 degrees Celsius, at least 40 degrees Celsius, at least 50 degrees Celsius, at least 60 degrees Celsius, at least 70 degrees Celsius, at least 80 degrees Celsius, at least 100 degrees Celsius, at least 150 degrees Celsius, or at least 200 degrees Celsius.

The concentrated composition can comprise a mixture of the non-polar organic solvent and the polar organic solvent. For example, the concentrated composition can comprise a weight ratio of the non-polar organic solvent to the polar organic solvent in a range of 80:1 to 1:8, such as, for example, 50:1 to 1:8, 20:1 to 1:4, 10:1 to 1:8, 12:1 to 1:4, 10:1 to 1:1, or 10:1 to 2:1. The weight ratio of the non-polar organic solvent to the polar organic solvent can enhance the storage stability of the wood preservative composition.

The concentrated composition can comprise a concentration of the non-polar organic solvent of at least 10% by weight based on the total weight of the composition, such as, for example, at least 20% by weight, at least 30% by weight, at least 40% by weight, at least 50% by weight, at least 60% by weight, at least 70% by weight, or at least 80% by weight all based on the total weight of the composition. The concentrated composition can comprise a concentration of the non-polar organic solvent in a range of 20% by weight to 80% by weight based on the total weight of the composition, such as, for example, 20% by weight to 70% by weight, 30% by weight to 70% by weight, 40% by weight to 70% by weight, or 40% by weight to 65% by weight, all based on the total weight of the composition.

The diluted treating composition can comprise a concentration of the non-polar organic solvent of at least 50% by weight based on the total weight of the composition, such as, for example, at least 60% by weight, at least 70% by weight, at least 80% by weight, or at least 90% by weight, all based on the total weight of the composition. The diluted treating composition can comprise a concentration of the non-polar organic solvent in a range of 50% by weight to 99% by weight based on the total weight of the composition, such as, for example, 50% by weight to 98% by weight, 60% by weight to 98% by weight, 70% by weight to 98% by weight, or 80% by weight to 96% by weight, all based on the total weight of the composition.

The polar organic solvent has large partial charges and/or dipole moments. The bonds between the atoms have very different but measurable electronegativities. For example, the polar organic solvent has a dielectric constant greater than 5. The polar organic solvent can dissolve ions and other polar compounds. The polar organic solvent, when used alone or used in combination with a non-polar organic solvents, can increase the solubility of the DCOI in the wood preservative composition, such that the DCOI can comprise a solubility of at least 10% by weight in the wood preservative composition, such as, for example at least 15% by weight, or higher as desired. The polar organic solvent may lead to undesirable emulsion formation with water during a treating process so the amount of the polar organic solvent should be balanced between increasing solubility while avoiding emulsion formation.

The concentrated composition can comprise the polar organic solvent. The diluted treating composition may or may not comprise the polar organic solvent, depending on if it was produced from the concentrated composition or directly formulated. The polar organic solvent can comprise a polar protic solvent, a polar aprotic solvent, or a combination thereof. A polar protic solvent contains an OH group and/or an NH group that is able to form hydrogen bonds. Polar protic solvents are highly polar because of the OH group and/or NH group. For example, the polar protic solvent has a dielectric constant greater than 15. The polar aprotic solvent has a medium range of polarity. The polar aprotic solvent has a polar bonds of C—O, S═O, or the like, which typically have a polarity less than that of an OH group and an NH group. For example, the polar aprotic solvent has an dielectric constant in a range of 5 to 15.

A polar protic solvent containing an OH group can comprise amyl alcohol, benzyl alcohol, cyclohexanol, ethyl alcohol-denatured, 2-ethyl hexanol, Exxal 8® isooctyl alcohol, Exxal 10® isodecyl alcohol, Exxal 13® Tridecyl Alcohol, furfuryl alcohol, isobutyl alcohol, isopropyl alcohol 99% anhy, methanol, methyl amyl alcohol (MIBC), n-butyl alcohol, n-propyl alcohol, Neodol® Linear Alcohol, secondary butyl alcohol, tertiary butyl alcohol, tetrahydrofurfuryl alcohol, Texanol Ester Alcohol®, UCAR Filmer IBT®, diethylene glycol, dipropylene glycol, ethylene glycol, glycerine 96%, 99%, U.S.P., glycerine, hexylene glycol, Neol® neopentyiglycol, polyethylene glycol, polypropylene glycol, Propylene Glycol Ind., U.S.P., tetraethylene glycol, triethylene glycol, tripropylene glycol, or a combination thereof. In various examples, the polar organic solvent comprises benzyl alcohol.

A polar protic sovlent containing an NH group can comprise diamylamine, diethylamine, diisopropylamine, dimethylethylamine, di-n-butylamine, mono-2-ethylhexyamine, monoamylamine, monoethylamine 70%, monoisopropylamine, anhy., mono-n-butylamine, triamylamine, triethylamine, tri-n-butylamine, dibutylaminoethanol, diethylaminoethanol, diethylaminoethoxyethanol, diisopropylaminoethanol, dimethylamino-2P, 77% mixed, simethylamino-2-P, anhy., dimethylaminoethanol, dimethylaminoethoxyethanol, ethylaminoethanol, ethylaminoethanol, mixed, isopropylaminoethanol, isopropylaminoethanol, mixed, methyldiethanolamine, monomethylaminoethanol, mono-n-propylaminoethanol, n-butylaminoethanol, n-butyldiethanolamine, n-butyldiethanolamine, photo, t-butylaminoethanol, t-butyldiethanolamine, diethanolamine, donoethanolamine, triethanolamine, triethanolamine 85%/99%, diisopropanolamine, monoisopropanolamine, triisopropanolamine, aminoethylethanolamine, aminoethylpiperazine, diethylenetriamine, ethylenediamine, piperazine 65%/anhy., piperazine, tetraethylenepentamine, triethylenetetramine, 3-methoxypropylamine, AMP® Regular/95, cyclohexylamine, morpholine, Neutrol TE®, or a combination thereof.

The polar aprotic solvent can comprise acetone, cyclohexanone, diacetone, diisobutyl ketone (DIBK), isophorone, methyl amyl ketone (MAK), methyl ethyl ketone (MEK), methyl isoamyl ketone (MIAK), methyl isobutyl ketone (MIAK), methyl propyl ketone (MPK), methylene chloride, monochlorobenzene, orthodichlorobenzene, perchloroethylene, trichloroethylene, Vertrel®. Hydrofluorocarbon, amyl acetate, dibasic ester, ethyl acetate, 2 ethyl hexyl acetate, ethyl propionate, Exxate® acetate esters, isobutyl acetate, isobutyl isobuterate, isopropyl acetate, n-butyl acetate, n-butyl propionate, n-pentyl propionate, n-propyl acetate, dimethyl sulfoxide (DMSO), dimethylformamide (DMF), tetrahydrofuran (THF), or a combination thereof.

The concentration of the polar solvent in the wood preservative composition (whether concentrated or diluted) can be balanced with the concentration of the DCOI used in the wood preservative composition according to the present disclosure to achieve a desired solubility of the DCOI in a wood product treated with the wood preservative composition according to the present disclosure and/or a desired stability of a wood preservative composition according to the present disclosure. For example, a weight ratio of the DCOI to the polar organic solvent in the wood preservative composition (concentrated or diluted) can be in a range of 1:5 to 100:1, such as, for example, 1:4 to 50:1, 1:3 to 25:1, 1:2 to 10:1, 1:1 to 5:1, 1.5:1 to 1:1.5, or 1.1:1 to 1:1.1. In various examples, a weight ratio of the DCOI to the polar organic solvent can be 2:1.

The concentrated composition according to the present disclosure can comprise a concentration of the polar organic solvent of at least 1% by weight based on the total weight of the composition, such as, for example, at least 5% by weight, at least 10% by weight, at least 20% by weight, at least 30% by weight, at least 40% by weight, or at least 50% by weight, all based on the total weight of the composition. The wood preservation composition according to the present disclosure can comprise a concentration of the polar organic solvent of no greater than 80% by weight based on the total weight of the composition, such as, for example, no greater than 55% by weight, no greater than 30% by weight, or no greater than 25% by weight, all based on the total weight of the composition. For example, the wood preservative composition can comprises a concentration of the polar organic solvent in a range of 1% by weight to 80% by weight based on the total weight of the composition, such as, for example, 5% by weight to 60% by weight, 1% by weight to 40% by weight, 10% by weight to 40% by weight, 10% by weight to 25% by weight, or 15% by weight to 25% by weight, all based on the total weight of the composition. For example, the wood preservative composition according to the present disclosure can comprise 15% by weight of the polar organic solvent based on the total weight of the composition.

In examples where the diluted treating composition comprises a polar organic solvent (either from production from the concentrated composition or purposeful addition), the diluted treating composition according to the present disclosure can comprise a concentration of the polar organic solvent of at least 0.1% by weight based on the total weight of the composition, such as, for example, at least 2% by weight, at least 5% by weight, or at least 10% by weight, all based on the total weight of the composition. The diluted treating composition according to the present disclosure can comprise a concentration of the polar organic solvent of no greater than 10% by weight based on the total weight of the composition, such as, for example, no greater than 9% by weight, no greater than 8% by weight, no greater than 7% by weight, no greater than 6% by weight, no greater than 5% by weight, no greater than 4% by weight, no greater than 3% by weight, or no greater than 0.5% by weight, all based on the total weight of the composition. For example, the diluted treating composition can comprise a concentration of the polar organic solvent in a range of 0.1% by weight to 10% by weight based on the total weight of the composition, such as, for example, 2% by weight to 10% by weight, 1% by weight to 8% by weight, or 1% by weight to 5% by weight.

Water may be present in the wood preservative composition according to the present disclosure that can lead to the formation of stable emulsions that can affect the treatment of a wood product. The wood preservative composition according to the present disclosure can be formulated with a de-emulsifier that can inhibit emulsion formation and facilitate water separation from the organic solvent phase. In various examples, the de-emulsifier can comprise a surfactant, a defoamer, an anti-foaming agent, other type of surface modifying agent, or a combination thereof. The de-emulsifier can comprise a siloxane (e.g., a polysiloxane, a 3-dimensional siloxane), a polysilane, an alkylphenol formaldehyde resin alkoxylate, a polyalkylene glycol, a sulfonate (e.g., an organic sulfonate), a polyglycol ether, a phenol oxylate, a naltyl phenol acetoxide derivative, or a combination thereof. For example, the de-emulsifier can comprise a Stepan series de-emulsifiers (e.g., Agent NE-3A, NE-3B, Toximul 8244); Dow Chemicals DM series de-emulsifiers (e.g., DM3, DM5, DM6); Evonik Tego Foamex series de-emulsifiers (e.g., 843, 844, 883, Surfynol 420); Demtrol series de-emulsifiers (e.g., 1030, 1040, 1130, 1135E, 2030, 2045, 4026, 6055, 6237); Reziflow series de-emulsifiers (e.g., 2110, 2215, 2130, 2140, 2205, 2210, 2300, 2305, 2600, 2605, 2720, 2740); a Munzing series of FOAM BAN products (FOAM BAN® 130B, 149, 152, 1536, 154, 155, 1550, 159, 169, 1820, 1839, 1840, 1849, 1860, 1875, 1880, 1890, 204, 225D, 257, 2642, 267D, 2699, 3057, 3555, 3633E, 4901, 4940, 4950, 4960, 4990, EC200, EC210, HP750, HP753N, HP758, HP920, HP930, HP939, HP940, HP949, HP970, HP979, HP980, HP990, MS-525, MS-550, MS-575, MS-5A, SB-73, TK-150, TK-320, Tk-340, Tk-360, TK-75 and TS-2000) or a combination thereof.

The wood preservative composition (whether concentrated or diluted) can comprise a concentration of the de-emulsifier of at least 10 ppm by weight based on the total weight of the composition, such as, for example, at least 100 ppm by weight, at least 200 ppm, at least 500 ppm by weight, at least 1% by weight, at least 2% by weight, or at least 5% by weight, all based on the total weight of the composition. The wood preservative composition (whether concentrated or diluted) can comprise a concentration of the de-emulsifier of no greater than 10% by weight based on the total weight of the composition, such as, for example, no greater than 5% by weight, no greater than 1% by weight, no greater than 0.1% by weight, no greater than 0.05% by weight, no greater than 0.02% by weight, or no greater than 0.01% by weight, all based on the total weight of the composition. The wood preservative composition (whether concentrated or diluted) can comprise a concentration of the de-emulsifier in a range of 10 ppm by weight to 10% by weight based on the total weight of the composition, such as, for example, 10 ppm by weight to 1% by weight based on the total weight of the composition. For example, a weight ratio of the DCOI to the de-emulsifier can be in a range of 5,000:1 to 1:20, such as, for example, 5,000:1 to 1,000:1, 5,000:1 to 1:1, 3,000:1 to 1:10, 2,500:1 to 1:2, 500:1 to 1:1, or 500:1 to 1:20.

The wood preservative composition (whether concentrated or diluted) may not phase separate when stored at ambient temperature (i.e., 21 degrees Celsius+/−2 degrees) or cold temperatures for at least 2 hours, such as, for example, the wood preservative composition may not phase separate when stored at 4 degrees Celsius for at least 2 hours, such as, for example, at least 24 hours, at least 48 hours, or at least 72 hours. For example, the concentrated composition may have superior stability at cold temperatures and the DCOI may remain soluble in the wood preservative composition during the cold storage even in light of the increased DCOI concentration.

The wood preservative composition according to the present disclosure can also optionally comprise a colorant, an ultraviolet (UV) stabilizer, a UV absorber, de-foamer, a water repellent, an additional biocide, a fungicide, a termiticide, a fire retardant, or a combination thereof. The UV stabilizer can comprise copper oxide, a copper salt, iron oxide, iron complexes, transparent iron oxide, iron salts, nanoparticle iron oxide, titanium dioxide, benzophenone, substituted benzophenones, cinnamic acid, esters of cinnamic acid, amides of cinnamic acid, substituted triazines (e.g., triphenyl triazaine, substituted phenyl triazine), or combinations thereof. The UV absorber can comprise benzotriazole, substituted benzotriazole, hindered amine light stabilizers, or combinations thereof. The water repellent can comprise a wax water repellent (e.g., paraffin wax, polyethylene wax, carnauba wax, slack wax), a silicone, or a combination thereof.

The fire retardant can be one or more compounds selected from the group consisting of inorganic metal oxides, hydroxides, salts and expandable graphite phosphate compounds, nitrogen-containing compounds, dipentaerythritol, pentaerythritol, dextrin and boron-containing compounds.

The additional biocide can comprise a creosote, a triazole, an imidazole, a pyrazole, a boron compound, a quaternary ammonium, an isothiazolone, a pyrethroid, copper metal, a copper compound (e.g., copper napthenate), pentachlorophenol, bethoxazin, or a combination thereof.

Triazole and imidazole can comprise: 1-[[2-(2,4-dichlorophenyl)-1,3-dioxolan-2-yl] methyl]-1H-1,2,4-triazole (azaconazole), 1-[(2RS,4RS: 2RS,4SR)-4-bromo-2-(2,4-dichlorophenyl) tetrahydrofurfuryl]-1H-1,2,4-triazole (bromuconazole), (2RS,3RS;2RS,3SR)-2-(4-chlorophenyl)-3-cyclopropyl-1-(1H-1,2,4-triazol-1-yl) butan-2-ol (Cyproconazole), (2RS,3RS)-1-(2,4-dichlorophenyl)-4,4-dimethyl-2-(1H-1,2,4-triazol-1-yl) pentan-3-ol (diclobutrazol), cis-trans-3-chloro-4-[4-methyl-2-(1H-1,2,4-triazol-1-ylmethyl)-1,3-dioxolan-2-yl] phenyl 4-chlorophenyl ether (difenoconazole), (E)-(RS)-1-(2,4-dichlorophenyl)-4,4-dimethyl-2-(1H-1,2,4-triazol-1-yl) pent-1-en-3-ol (diniconazole), (E)-(R)-1-(2,4-dichlorophenyl)-4,4-dimethyl-2-(1H-1,2,4-triazol-1-yl) pent-1-en-3-ol (diniconazole-M), (2RS,3SR)-1-[3-(2-chlorophenyl)-2,3-epoxy-2-(4-fluorophenyl) propyl]-1H-1,2,4-triazole (epoxiconazole), (RS)-1-[2-(2,4-dichlorophenyl)-4-ethyl-1,3-dioxolan-2-ylmethyl]-1H-1,2,4-triazole (etaconazole), (RS)-4-(4-chlorophenyl)-2-phenyl-2-(1H-1,2,4-triazol-1-ylmethyl) butyronitrile (fenbuconazole), 3-(2,4-dichlorophenyl)-6-fluoro-2-(1H-1,2,4-triazol-1-yl) quinazolin-4 (3H)-one (fluquinconazole), bis (4-fluorophenyl) (methyl) (1H-1,2,4-triazol-1-ylmethyl) silane (flusilazole), (RS)-2,4′-difluoro-a-(1H-1,2,4-triazol-1-ylmethyl) benzhydryl alcohol (flutriafol), (2RS,5RS;2RS,5SR)-5-(2,4-dichlorophenyl) tetrahydro-5-(1H-1,2,4-triazol-1-ylmethyl)-2-furyl 2,2,2-trifluoroethyl ether (furconazole), (2RS,5RS)-5-(2,4-dichlorophenyl) tetrahydro-5-(1H-1,2,4-triazol-1-ylmethyl)-2-furyl 2,2,2-trifluoroethyl ether (furconazole-cis), (RS)-2-(2,4-dichlorophenyl)-1-(1H-1,2,4-triazol-1-yl) hexan-2-ol (hexaconazole), 4-chlorobenzyl (EZ)-N-(2,4-dichlorophenyl)-2-(1H-1,2,4-triazol-1-yl) thioacetamidate (imibenconazole), (1RS,2SR,5RS;1RS,2SR,5SR)-2-(4-chlorobenzyl)-5-isopropyl-1-(1H-1,2,4-triazol-1-ylmethyl) cyclopentanol (ipconazole), (1RS,5RS;1RS,5SR)-5-(4-chlorobenzyl)-2,2-dimethyl-1-(1H-1,2,4-triazol-1-ylmethyl) cyclopentanol (metconazole), (RS)-2-(4-chlorophenyl)-2-(1H-1,2,4-triazol-1-ylmethyl) hexanenitrile (myclobutanil), (RS)-1-(2,4-dichloro-β-propylphenethyl)-1H-1,2,4-triazole (penconazole), cis-trans-1-[2-(2,4-dichlorophenyl)-4-propyl-1,3-dioxolan-2-ylmethyl]-1H-1,2,4-triazole (propiconazole), (RS)-2-[2-(1-chlorocyclopropyl)-3-(2-chlorophenyl)-2-hydroxypropyl]-2,4-dihydro-1,2,4-triazole-3-thione (prothioconazole), 3-(2,4-dichlorophenyl)-2-(1H-1,2,4-triazol-1-yl)-quinazolin-4 (3H)-one (quinconazole), (RS)-2-(4-fluorophenyl)-1-(1H-1,2,4-triazol-1-yl)-3-(trimethylsilyl) propan-2-ol (simeconazole), (RS)-1-p-chlorophenyl-4,4-dimethyl-3-(1H-1,2,4-triazol-1-ylmethyl) pentan-3-ol (tebuconazole), propiconazole, (RS)-2-(2,4-dichlorophenyl)-3-(1H-1,2,4-triazol-1-yl) propyl 1,1,2,2-tetrafluoroethyl ether (tetraconazole), (RS)-1-(4-chlorophenoxy)-3,3-dimethyl-1-(1H-1,2,4-triazol-1-yl) butan-2-one (triadimefon), (1RS,2RS; 1RS,2SR)-1-(4-chlorophenoxy)-3,3-dimethyl-1-(1H-1,2,4-triazol-1-yl) butan-2-ol (triadimenol), (RS)-(E)-5-(4-chlorobenzylidene)-2,2-dimethyl-1-(1H-1,2,4-triazol-1-ylmethyl) cyclopentanol (triticonazole), (E)-(RS)-1-(4-chlorophenyl)-4,4-dimethyl-2-(1H-1,2,4-triazol-1-yl) pent-1-en-3-ol (uniconazole), (E)-(S)-1-(4-chlorophenyl)-4,4-dimethyl-2-(1H-1,2,4-triazol-1-yl) pent-1-en-3-ol (uniconazole-P), 2-(2,4-difluorophenyl)-1-(1H-1,2,4-triazole-1-yl)-3-trimethylsilyl-2-propanol, or a combination thereof. Other azole compounds suitable as an additional biocide can comprise amisulbrom, bitertanol, fluotrimazole, triazbutil, climbazole, clotrimazole, imazalil, oxpoconazole, prochloraz, triflumizole, azaconazole, simeconazole, hexaconazole, or a combination thereof.

The pyrazole can comprise: benzovindiflupyr, bixafen, fenpyrazamine, fluxapyroxad, furametpyr, isopyrazam, oxathiapiprolin, penflufen, penthiopyrad, pydiflumetofen, pyraclostrobin, pyrametostrobin, pyraoxystrobin, rabenzazole, sedaxane, or a combination thereof.

The boron compound can comprise water-insoluble boron compounds, such as, for example, metal borate compounds (e.g., calcium borate, borate silicate, aluminum silicate borate hydroxide, silicate borate hydroxide fluoride, hydroxide silicate borate, sodium silicate borate, calcium silicate borate, aluminum borate, boron oxide, magnesium borate, iron borate, copper borate, zinc borate (borax)), or combinations thereof.

The quaternary ammonium can comprise didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly (oxyethyl) ammonium propionate, or a combination thereof.

The isothiazolone can comprise methylisothiazolinone; 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, preferably 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, etc., more preferably 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone, 4,5-Dichloro-2-n-octyl-3 (2H)-isothiazolone, 1,2-benzisothiazolin-3-one, or a combination thereof.

The pyrethroid can comprise: acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, or a combination thereof.

The additional biocide can comprise imidachloprid, fipronil, cyfluthrin, bifenthrin, permethrin, cypermethrin, chlorpyrifos, iodopropynyl butylcarbamate (IPBC), chlorothalonil, 2-(thiocyanatomethylthio) benzothiazole, alkoxylated diamines, carbendazim, or a combination thereof. The additional biocide can comprise a bactericide, a moldicide, or a combination thereof.

The wood preservative composition (whether concentrated or diluted) can comprise a flash point suitable for handling and/or a desirable treatment application. For example, the wood preservative composition can comprise a flash point of at least 20 degrees Celsius, such as, for example, at least 30 degrees Celsius, at least 40 degrees Celsius, at least 50 degrees Celsius, at least 60 degrees Celsius, at least 70 degrees Celsius, at least 80 degrees Celsius, at least 100 degrees Celsius, at least 110 degrees Celsius, at least 120 degrees Celsius, at least 130 degrees Celsius, or at least 140 degrees Celsius.

The present disclosure also provides a method for making the wood preservative composition. The method can comprise dissolving the DCOI in the non-polar organic solvent, thereby forming the wood preservative composition. In various examples, the de-emulsifier and/or polar organic solvent may be added to the organic solvent and/or other component (e.g., a colorant, an ultraviolet stabilizer, a de-foamer, a water repellent, an additional biocide, a fungicide, a termiticide, a fire retardant or a combination thereof). In various examples, the wood preservative composition according to the present disclosure is made by dissolving the DCOI in the non-polar organic solvent, thereby forming an intermediate mixture followed by mixing the intermediate mixture with the de-emulsifier.

If the wood preservative composition according to the present disclosure is formulated as a concentration composition, the concentration composition can be diluted with another non-polar organic solvent, that may be the same or different than the non-polar organic solvent used to formulate the concentrated composition, prior to treating a wood substrate with the wood preservative composition. In certain examples, the concentrated formulation may be formed by mixing the DCOI with the non-polar organic solvent at a temperature above the melting point of DCOI. The resulting concentrate can be in a liquid form at 20 degrees Celsius. In addition, the resulting concentrate can be further diluted in a non-polar organic solvent to make the final wood preservative treating composition. In certain examples, the concentrated formulation may be used to treat a wood substrate to form a wood product.

The present disclosure also provides a method of treating a wood substrate, thereby forming a wood product. The method comprises contacting a wood substrate with the wood preservative composition according to the present disclosure for a period of time suitable to inhibit fungal decay of the wood substrate. The method of treating the wood substrate can inhibit biological deterioration (e.g., fungal decay) and insect attack of the wood product (e.g., termite attack). The contacting can be performed until the wood product retains at least 0.05 pounds of DCOI per cubic foot (pcf) of the wood product, such as, for example, at least 0.10 pounds of DCOI pcf of the wood product or at least 0.15 pounds of DCOI pcf of the wood product.

Contacting the wood substrate can comprise dipping, soaking, spraying, brushing, a vacuum process, a pressure process, a microwave process, or a combination thereof. For example, the contacting can comprise a modified full-cell process, an empty-cell process, or a combination thereof. In various examples, contacting comprises the empty-cell process and the empty-cell process comprises a Rueping process and a Lowry process. For example, in the empty-cell process, prior to the introduction of wood preservative composition according to the present disclosure, the wood substrate is subjected to atmospheric air pressure (Lowry) or to higher air pressures than atmospheric (Rueping) of the necessary intensity and duration. Various example contacting processes that can be used with the present disclosure are defined in the American Wood Protection Association (AWPA) Book of Standards T1-21: Processing and Treatment Standard, which is hereby incorporated by reference.

The wood substrate may inherently contain some water that can form an emulsion with the wood preservative composition. An increased amount (e.g., greater than 30% by total weight of the composition) of water in the wood preservative composition may lead to undesirable treatment of the wood product and/or replacement of the wood preservative composition. Use of the de-emulsifier in the wood preservative composition can inhibit emulsion formation and lead to enhanced efficiency of separation of water and/or other aqueous phase from the wood preservative composition. For example, after treating a wood product, the wood preservative composition may be left in a vessel where an aqueous phase forms that substantially contains water and an organic phase that substantially contains the wood preservative composition. The aqueous phase may be separated from the organic phase in various manners, such as, for example, decanting. Then, the organic phase can be re-used to treat wood substrates.

The present disclosure also provides a wood product produced by treating a wood substrate with the wood preservative composition according to the present disclosure. The wood product can comprise timber, plywood, laminated veneer lumber (LVL), cross laminated timber (CTL), parallel strand lumber (PSL), structural glued laminated timber, particle board, dimensional lumber, or a combination thereof. In various examples, the wood product comprises a deck, a rail, a fence, a utility pole, a pile, a railway tie, a railroad bridge, cladding, siding, or a combination thereof. For example, the wood product can comprise a utility pole.

The wood product can comprise various species of wood. For example, the wood product can comprise southern pine, Douglas fir, Jack pine, red pine, Lodgepole pine, radiata pine, Alaska yellow cedar, Hem-fir, Nordic pine, Scotts pine, white spruce, Spruce-Pine-Fir, redwood, white oak, red oak, maple, black and red gum, Norway spruce, Sitka spruce, western red cedar, western larch, ponderosa pine, or a combination thereof.

### Examples

The present disclosure will be more fully understood by reference to the following examples, which provide illustrative non-limiting aspects of the invention. It is understood that the invention described in this specification is not necessarily limited to the examples described in this section.

### #2 Diesel Solvency for DCOI Testing

Solvency (i.e., ability to dissolve) of #2 diesel for DCOI was measured. Initially, different amounts of DCOI (98.5% purity) was dissolved in #2 diesel in respective vials to make a DCOI concentrate. Thereafter, the vials were stored at ambient temperature (i.e., 21 degrees Celsius+/−2 degrees) or 4 degrees Celsius for up to 7 days. During storage, the vials were monitored for phase separation, precipitation, and turbidity, which may indicate incompatibility between the organic solvent and the DCOI. Whenever a phase separation, precipitation or solution turbidity event happened, the vial was no longer monitored and the DCOI concentration in that solution was considered to be higher than the solvency of the organic solvent.

After two hours of storage at ambient temperature, it was observed that the solvency of #2 diesel for DCOI without any additional polar solvents was no greater than 15% by weight because the DCOI precipitated in the vials containing concentrations of DCOI of greater than 15% by weight. The vials containing concentrations of DCOI of no greater than 15% by weight did not precipitate solid DCOI after 7 days. Therefore, the maximum solvency of #2 diesel is for DCOI was determined to be 15% by weight.

### Wood Preservative Concentrated Solution Solvency Testing

The solvency of a mixture of non-polar and polar solvent for DCOI was measured. Initially, DCOI (98.5% purity) was dissolved in a mixture of a non-polar solvent, #2 diesel, and a polar solvent, benzyl alcohol, in varying weight ratios to make concentrated solution examples A-E. Each concentrated solution example had a DCOI concentration of 23% by weight based on the total weight of the concentrated solution. The concentrated solutions example compositions are listed in Table 1 below:

TABLE 1
Concentrated Solution Examples

| Concentrated | DCOI | #2 Diesel | Benzyl alcohol | Weight Ratio of |
|---|---|---|---|---|
| Solution | Concentration | Concentration | concentration | #2 Diesel To |
| Examples | (% by weight) | (% by weight) | (% by weight) | Benzyl Alcohol |
| A | 23 | 71 | 6 | 11.8:1 |
| B | 23 | 69 | 8 | 8.6:1 |
| C | 23 | 67 | 10 | 6.7:1 |
| D | 23 | 37 | 40 | 1:1.08 |
| E | 23 | 17 | 60 | 1:3.5 |

Thereafter, concentrated solution examples A-E were added to vials that were stored at ambient temperature (i.e., 21 degrees Celsius+/−5 degrees) or 4 degrees Celsius for up to 7 days. During storage, the vials were monitored for phase separation, precipitation, and turbidity, which may indicate incompatibility between the organic solvent and the retaining additive and/or DCOI. Whenever a phase separation, precipitation or solution turbidity event happened, the vial was no longer monitored and the DCOI concentration in that concentrated solution example was considered to be higher than the solvency of the organic solvent mixture.

After storage at 4 degrees Celsius for 3 hours, concentrated solution example A was observed to have a great amount of precipitation and concentrated solution example B also was also observed to have precipitate. It is believed this precipitate occurred in under two hours even though formal observations were only documented at 3 hours. For concentrated solution examples C-E, no separation, precipitation, or tubidity events were observed and concentrated solution examples C-E did not have a separation, precipitation, or tubitiy event after 7 days of storage at 4 degrees Celsius and therefore are considered stable at cold temperatures.

### Diluted Wood Preservative Treating Solution

Concentrated solution examples C-E were further evaluated by diluting by 10 fold to form respective diluted treating solutions C-E with compositions as shown in Table 2 below. For example, 90 g of #2 diesel and 10 grams of the respective concentrated solution example C, D, or E was added under agitation to a 100 ml beaker until a homogenous solution was formed.

TABLE 2
Diluted Solution Examples

| Diluted | DCOI | #2 Diesel | Benzyl alcohol | |
|---|---|---|---|---|
| Solution | Concentration | Concentration | concentration | De-Emulsifer |
| Examples | (% by weight) | (% by weight) | (% by weight) | (% by weight) |
| C | 2.3 | 96.7 | 1 | 6.7:1 |
| D | 2.3 | 93.7 | 4 | 1:1.08 |
| E | 2.3 | 91.7 | 6 | 1:3.5 |

Diluted solution examples C-E were observed to be stable at ambient temperature after mixing and would be expected to suitably inhibit fungal decay in a wood substrate.

### De-Emulsifier Evaluation

200 ppm of various de-emulsifiers as listed in Table 3 were added to diluted solution examples C-E. Additionally, a control containing no de-emulsifier was tested.

To evaluate the effectiveness of the various de-emulsifiers, 10 ml of tap water was added to 10 ml of each of diluted solution examples C-E containing the respective de-emulsifier and the control diluted solution examples C-E in a glass vial and mixed thoroughly. Then a line was placed on the vial at the water/oil interface with a marker. Thereafter, the vial was mixed for 10 seconds using a vortex mixer. After mixing, the vial was placed on a countertop and observed to determine if the water would separate from the respective example using the previously marked line as a reference. It was observed that the water separated from the organic phase in control diluted solution example C after 2 minutes but the water did not separate from the organic phase in diluted control solution examples D-E after 2 minutes.

The results of the diluted treating solutions C-E with the various de-emulsifiers is shown in Table 3 below:

TABLE 3
De-emulsifiers and results obtained

| De-emulsifier | Observations |
|---|---|
| Foam Ban | Water separation from the organic phase was observed to |
| HV-830 | start after 60 seconds. Most of the water has separated from |
| | the organic phase after 2 minute. |
| Surfynol 420 | Water separation from the organic phase was observed to |
| | start after 1.5 minutes. Close to 70% of water was observed |
| | to be separate from the organic phase by 5 minutes and 95% |
| | of water was observed to separate from the organic phase by |
| | 6.5 minutes. |
| Emulsogen | Water separation from the organic phase was observed to |
| EL 360A | start after 2 minutes. Close to 50% of water was observed to |
| | separate from the organic phase by 5 minutes and 90% of |
| | water was observed to separate from the organic phase by |
| | 6.5 minutes. |
| Foam Ban | Water separation from the organic phase was observed to |
| WP-35 | start after 15 seconds. Close to 90% of water was observed |
| | to separate from the organic phase by 1 minute. |
| Foam Ban | Water separation from the organic phase was observed to |
| MS-550 | start after 20 seconds. Close to 90% of water was observed |
| | to separate from the organic phase by 1 minute and 95% of |
| | water had separate from the organic phase by 2 minutes. |

It was observed that the de-emulsifier enhances the water separation in the diluted treating solution examples such that the diluted treating solution examples could be used to treat multiple wood substrates.

### DCOI Concentrate in Polar/Non-Polar Combo Solvent Example 1

23.0% of DCOI in a mixture of #2 diesel and benzyl alcohol was made by adding 23.35 g of DCOI followed by adding 4 g of benzyl alcohol into 72.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 2

23.0% of DCOI in a mixture of #2 diesel and benzyl alcohol was made by adding 23.35 g of DCOI followed by adding 6 g of benzyl alcohol into 70.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 3

23.0% of DCOI in a mixture of #2 diesel and benzyl alcohol was made by adding 23.35 g of DCOI followed by adding 8 g of benzyl alcohol into 68.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 4

23.0% of DCOI in a mixture of #2 diesel and benzyl alcohol was made by adding 23.35 g of DCOI followed by adding 10 g of benzyl alcohol into 66.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 5

23.0% of DCOI in a mixture of #2 diesel and benzyl alcohol was made by adding 23.35 g of DCOI followed by adding 12 g of benzyl alcohol into 64.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 6

23.0% of DCOI in a mixture of #2 diesel and benzyl alcohol was made by adding 23.35 g of DCOI followed by adding 15 g of benzyl alcohol into 61.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 7

23.0% of DCOI in a mixture of #2 diesel and benzyl alcohol was made by adding 23.35 g of DCOI followed by adding 20 g of benzyl alcohol into 56.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 8

23.0% of DCOI in a mixture of #2 diesel and benzyl alcohol was made by adding 23.35 g of DCOI followed by adding 30 g of benzyl alcohol into 46.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 9

23.0% of DCOI in a mixture of #2 diesel and benzyl alcohol was made by adding 23.35 g of DCOI followed by adding 40 g of benzyl alcohol into 36.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 10

23.0% of DCOI in a mixture of #2 diesel and benzyl alcohol was made by adding 23.35 g of DCOI followed by adding 50 g of benzyl alcohol into 26.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 11

23.0% of DCOI in a mixture of #2 diesel and benzyl alcohol was made by adding 23.35 g of DCOI followed by adding 60 g of benzyl alcohol into 16.65 g of #2 diesel in a 100 ml glass vial under agitation at 25° C. until no more DCOI can be dissolved. The concentrate was stable without any solid precipitate at 4° C. for 2 months.

### DCOI Concentrate in Polar/Non-Polar Combo Solvent Example 12

23.0% of DCOI with de-emulsifier was made by adding 0.02 g of Foamban MS-550 to 10 g of solution of Combo Solvent Example 4 under agitation at 25° C. until a homogeneous solution is formed. A 2.5% dilute solution was prepared by mixing the above concentrate with #2 diesel. The 2.5% dilute solution was mixed with distilled water at a weight ratio of 1:1 in a graduated cylinder, and the graduated cylinder was stopped and then shaken vigorously ten times using up and down motion. After shaking, the graduated cylinder was set down on a lab bench table for observation of water separation. A clear water separation was observed within 2 minutes.

### DCOI Concentrate in Polar/Non-Polar Combo Solvent Example 13

23.0% of DCOI with de-emulsifier was made by adding 0.02 g of Foamban MS-550 to 10 g of solution of Combo Solvent Example 8 under agitation at 25° C. until a homogeneous solution is formed. A 2.2% DCOI dilute solution was prepared by mixing the above concentrate with #2 diesel. The 2.2% dilute solution was mixed with distilled water at a weight ratio of 1:1 in a graduated cylinder, and the graduated cylinder was stopped and then shaken vigorously ten times using up and down motion. After shaking, the graduated cylinder was set down on a lab bench table for observation of water separation. A clear water separation was observed within 2 minutes.

### DCOI Concentrate in Polar/Non-Polar Combo Solvent Example 14

23.0% of DCOI with de-emulsifier was made by adding 0.02 g of Foamban MS-550 to 10 g of solution of Combo Solvent Example 9 under agitation at 25° C. until a homogeneous solution is formed. A 2.0% dilute solution was prepared by mixing the above concentrate with #2 diesel. The 2.0% dilute solution was mixed with distilled water at a weight ratio of 1:1 in a graduated cylinder, and the graduated cylinder was stopped and then shaken vigorously ten times using up and down motion. After shaking, the graduated cylinder was set down on a lab bench table for observation of water separation. A clear water separation was observed within 2 minutes.

### DCOI Concentrate in Polar/Non-Polar Combo Solvent Example 15

23.0% of DCOI with de-emulsifier was made by adding 0.02 g of Foamban MS-550 to 10 g of solution of Combo Solvent Example 11 under agitation at 25° C. until a homogeneous solution is formed. A 3.0% dilute solution was prepared by diluting the above concentrate with a mixture solvents of biodiesel and #2 diesel (the weight ratio of biodiesel to #diesel=3:1). The 3.0% dilute solution was mixed with distilled water at a weight ratio of 1:1 in a graduated cylinder, and the graduated cylinder was stopped and then shaken vigorously ten times using up and down motion. After shaking, the graduated cylinder was set down on a lab bench table for observation of water separation. A clear water separation was observed within 5 minutes.

### DCOI Concentrate in Polar/Non-Polar Combo Solvent Example 16

23.0% of DCOI with de-emulsifier was made by adding 0.02 g of Foam Ban HV-830G to 10 g of solution of Combo Solvent Example 11 under agitation at 25° C. until a homogeneous solution is formed. A 2.2% dilute DCOI solution was prepared by mixing the above concentrate with #2 diesel. Distilled water was mixed and agitated with southern yellow pine sawdust at a weight ratio of 1:1 for about 4 hours. After agitation, the wood sawdust was filtered out and the water sample containing wood extractives was obtained. The 2.2% dilute DCOI solution was mixed with the above water sample containing wood extractives at a weight ratio of 1:1 in a graduated cylinder, and the graduated cylinder was stopped and then shaken vigorously ten times using up and down motion. After shaking, the graduated cylinder was set down on a lab bench table for observation of water separation. A clear water separation was observed within 5 minutes.

### DCOI Concentrate in Polar/Non-Polar Combo Solvent Example 17

23.0% of DCOI with de-emulsifier was made by adding 0.02 g of Surfynol 420 to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 18

23.0% of DCOI with de-emulsifier was made by adding 0.02 g of Foam Ban WP-35 to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 19

23.0% of DCOI with de-emulsifier was made by adding 0.02 g of Tego Foamex 883 to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 20

23.0% of DCOI with de-emulsifier was made by adding 0.02 g of Emulsogen EL 360A to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 21

23.0% of DCOI with de-emulsifier was made by adding 0.02 g of PDB 9904 to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 22

23.0% of DCOI with de-emulsifier was made by adding 0.02 g of Basarol 1301 to 10 g of solution of Combo Solvent Example 11 under agitation at 25° C. until a homogeneous solution is formed. The concentrate was stable without any solid precipitate at 4° C. for 2 months.

### DCOI Concentrate in Polar/Non-Polar Combo Solvent Example 23

23.0% of DCOI with de-emulsifier was made by adding 0.02 g of Foam Ban WP-35 to 10 g of solution of Combo Solvent Example 11 under agitation at 25° C. until a homogeneous solution is formed. The concentrate was stable without any solid precipitate at 4° C. for 2 months.

In this specification, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein-described components, devices, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A wood preservative composition comprising:
at least 10% by weight of 4,5-dichloro-2-octylisothiazol-3-one (DCOI) based on the total weight of the composition;
at least 10% by weight of a non-polar organic solvent based on the total weight of the composition; and
at least 1% by weight of a polar organic solvent based on the total weight of the composition,
wherein a weight ratio of the non-polar organic solvent to the polar organic solvent is in a range of 80:1 to 1:10.

2. The wood preservative composition of claim 1, wherein the composition comprises 15% by weight to 45% by weight of the DCOI based on the total weight of the composition.

3. The wood preservative composition of claim 2, wherein the composition comprises 20% by weight to 30% by weight of the DCOI based on the total weight of the composition.

4. The wood preservative composition of claim 1, wherein a weight ratio of the non-polar organic solvent to the polar organic solvent is in a range of 12:1 to 1:4.

5. The wood preservative composition of claim 1, wherein the composition comprises 1% by weight to 40% by weight of the polar organic solvent based on the total weight of the composition.

6. The wood preservative composition of claim 1, wherein the composition comprises 30% by weight to 80% by weight of the non-polar organic solvent based on the total weight of the composition.

7. (canceled)

8. The wood preservative composition of claim 1, wherein the non-polar organic solvent comprises a non-polar hydrocarbon solvent, a non-polar ether solvent, a non-polar ester solvent, a non-polar aliphatic solvent, a non-polar aromatic solvent, a non-polar terpene solvent, a non-polar biodegradable organic solvent, or a combination thereof.

9. The wood preservative composition of claim 1, wherein the non-polar organic solvent comprises at least one of diesel and biodiesel.

10. The wood preservative composition of claim 1, wherein the non-polar organic solvent comprises a flash point of at least 50 degrees Celsius.

11. The wood preservative composition of claim 1, wherein the polar organic solvent is a polar protic solvent or a polar aprotic solvent.

12. The wood preservative composition of claim 1, wherein the polar organic solvent comprises a C═O bond, a S—O bond, an OH group, an NH group, or a combination thereof.

13. The wood preservative composition of claim 1, wherein the polar organic solvent comprises benzyl alcohol.

14. The wood preservative composition of claim 1, wherein the wood preservative composition consists of the DCOI, the non-polar organic solvent, the polar organic solvent, and optionally a de-emulsifier.

15. The wood preservative of claim 1, further comprising a de-emulsifier.

16. The wood preservative of claim 15, wherein the de-emulsifier comprises a siloxane, a polysilane, an alkylphenol formaldehyde resin alkoxylate, a polyalkylene glycol, a sulfonate, a polyglycol ether, a phenol oxylate, a naltyl phenol acetoxide derivative, or a combination thereof.

17. The wood preservative composition of claim 1, wherein the wood preservative composition does not have solid precipitate when stored at 4 degrees Celsius for 24 hours.

18. (canceled)

19. A method of treating a wood substrate, the method comprising:
diluting the wood preservative composition of claim 1 to form a diluted treating solution; and
contacting the wood substrate with the diluted treating solution for a period of time suitable to inhibit fungal decay of the wood substrate.

20. (canceled)

21. (canceled)

22. A wood product produced by treating a wood substrate with a diluted treating solution produced from the wood preservative composition of claim 1.

23. A wood product comprising a diluted treating solution produced from the wood preservative composition of claim 1.

24. The wood product of claim 22, wherein the wood product retains at least 0.05 pounds of DCOI per cubic foot of the wood product.

25. The wood product of claim 22, wherein the wood product comprises timber, plywood, laminated veneer lumber (LVL), cross laminated timber (CTL), parallel strand lumber (PSL), structural glued laminated timber, particle board, dimensional lumber, or a combination thereof.

26. The wood product of claim 22, wherein the wood product comprises a deck, a rail, a fence, a utility pole, a pile, a railway tie, a railroad bridge, cladding, siding, or a combination thereof.

27. (canceled)

28. (canceled)

29. A wood preservative composition comprising:
15% by weight to 45% by weight of 4,5-dichloro-2-octylisothiazol-3-one (DCOI) based on the total weight of the composition;
30% by weight to 80% by weight of a non-polar organic solvent based on the total weight of the composition; and
an amount of a polar organic solvent suitable to increase the stability of the wood preservative composition during storage at 4 degrees Celsius for 24 hours.

30. (canceled)

31. A wood preservative composition comprising:
at least 0.5% by weight of 4,5-dichloro-2-octylisothiazol-3-one (DCOI) based on the total weight of the composition;
at least 50% by weight of a non-polar organic solvent based on the total weight of the composition; and
at least 10 ppm by weight of a de-emulsifier based on the total weight of the composition.

32-48. (canceled)

49. A method of treating a wood substrate, the method comprising:
contacting the wood substrate with the wood preservative composition of claim 31 for a period of time suitable to inhibit fungal decay of the wood substrate.

50. (canceled)

51. (canceled)

52. A wood product produced by treating a wood substrate with the wood preservative composition of claim 31.

53. A wood product comprising the wood preservative composition of claim 31.

54. The wood product of claim 52, wherein the wood product retains at least 0.05 pounds of DCOI per cubic foot of the wood product.

55. The wood product of claim 52, wherein the wood product comprises timber, plywood, laminated veneer lumber (LVL), cross laminated timber (CTL), parallel strand lumber (PSL), structural glued laminated timber, particle board, dimensional lumber, or a combination thereof.

56. The wood product of claim 52, wherein the wood product comprises a deck, a rail, a fence, a utility pole, a pile, a railway tie, a railroad bridge, cladding, siding, or a combination thereof.

57. (canceled)

58. (canceled)

59. A wood preservative composition comprising:
0.5% by weight to 10% by weight of 4,5-dichloro-2-octylisothiazol-3-one (DCOI) based on the total weight of the composition;
50% by weight to 99% by weight of a non-polar organic solvent based on the total weight of the composition; and
an amount of a de-emulsifier suitable to enhance water separation from the wood preservative composition compared to a wood preservative composition without the de-emulsifier.

60. (canceled)

61. The wood preservative composition of claim 1, wherein the wood preservative composition does not have solid precipitate when stored at 10 degrees Celsius for 24 hours.

62. The wood preservative composition of claim 29, wherein the amount of the polar organic solvent is suitable to increase the stability of the wood preservative composition during storage at 10 degrees Celsius for 24 hours.
